(19) United States
(12) Patent Application Publication
(10) Pub. No.: US 2023/0058187 A1
(43) Pub. Date: Feb. 23, 2023

(54) WORKFLOW MANAGEMENT SYSTEM, WORKFLOW MANAGEMENT APPARATUS, AND NON-TRANSITORY COMPUTER READABLE MEDIUM

(71) Applicant: FUJIFILM Business Innovation Corp., Tokyo (JP)

(72) Inventor: Hironori TANAKA, Kanagawa (JP)

(73) Assignee: FUJIFILM Business Innovation Corp., Tokyo (JP)

(21) Appl. No.: 17/646,528

(22) Filed: Dec. 30, 2021

(30) Foreign Application Priority Data
Aug. 18, 2021 (JP) 2021-133108

(51) Int. Cl. G06F 9/30; G06F 9/445

(52) U.S. Cl. CPC G06F 9/3005; G06F 9/44505; G06F 9/30007

(57) ABSTRACT

A workflow management system includes: a first processor configured to execute workflow in an external environment; a second processor included in an information processing apparatus disposed in an internal environment involving limited access from the external environment; and a user terminal apparatus that is disposed in the external environment and that is used by a user for user operation of a file to be processed in the workflow. The first processor is configured to: receive the file to be processed in the workflow; in response to presence of confidentiality of the received file, cause the file to be held in the information processing apparatus after transmitting the file to the information processing apparatus; and in response to presence of confidentiality of a user-operation target file acquisition of which is requested by the user, give the second processor an instruction to transmit the user-operation target file to the user terminal apparatus. The second processor is configured to transmit the user-operation target file to the user terminal apparatus in response to the instruction from the first processor.

### CROSS-REFERENCE TO RELATED APPLICATIONS

This application is based on and claims priority under 35 USC 119 from Japanese Patent Application No. 2021-133108 filed Aug. 18, 2021

### BACKGROUND

### (i) Technical Field

The present disclosure relates to a workflow management system, a workflow management apparatus, and a non-transitory computer readable medium.

### (ii) Related Art

Companies conduct business in accordance with workflow on occasions. Specifically, in the workflow, predetermined work is carried out by executing, for example, a series of processes such as registration, editing, and approving a document in order.

In recent years, a working system called telework in which work is carried out at home is employed for working in some cases. The workflow is typically executed in an on-premise environment in the nature of the work; however, to execute the workflow also in an external environment such as a home outside the on-premise environment or in cooperative operations in the on-premise environment and the external environment, the workflow system is required to be installed in a cloud system in the external environment.

However, a confidential file is handled on occasions in the workflow. In the related art, there is proposed technology in which the confidentiality level of a file is determined, and a highly confidential file and a not highly confidential file are respectively processed in the on-premise environment and the cloud environment (for example, Japanese Unexamined Patent Application Publication No. 2019-040327 and Japanese Unexamined Patent Application Publication No. 10-326314).

### SUMMARY

It is favorable that a file required to be handled confidentially such as a file including confidential information in a company or the like be held in an internal environment with limited access from the external environment. In contrast, the spread of the telework has led to workflow increasingly executed in such a manner that a workflow system installed in the external environment is accessed from a terminal installed in the external environment.

Aspects of non-limiting embodiments of the present disclosure relate to enabling the confidentiality of a confidential file to be kept when a user handles the file in executing workflow in the external environment as compared with a case where the confidential file remains held in the external environment.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a workflow management system including: a first processor configured to execute workflow in an external environment; a second processor included in an information processing apparatus disposed in an internal environment involving limited access from the external environment; and a user terminal apparatus that is disposed in the external environment and that is used by a user for user operation of a file to be processed in the workflow, wherein the first processor is configured to: receive the file to be processed in the workflow; in response to presence of confidentiality of the received file, cause the file to be held in the information processing apparatus after transmitting the file to the information processing apparatus; and in response to presence of confidentiality of a user-operation target file acquisition of which is requested by the user, give the second processor an instruction to transmit the user-operation target file to the user terminal apparatus, and wherein the second processor is configured to: transmit the user-operation target file to the user terminal apparatus in response to the instruction from the first processor.

### BRIEF DESCRIPTION OF THE DRAWINGS

An exemplary embodiment of the present disclosure will be described in detail based on the following figures, wherein:

FIG. 1 is an overall configuration diagram illustrating the exemplary embodiment of a workflow management system according to the present disclosure;

FIG. 2 is an example table illustrating a data structure of workflow management information stored in a workflow-management information memory in this exemplary embodiment;

FIG. 3 is a flowchart illustrating a workflow registration process in this exemplary embodiment;

FIG. 4 is a flowchart illustrating a document storing process in this exemplary embodiment; and

FIG. 5 is a flowchart illustrating a workflow execution process in this exemplary embodiment.

### DETAILED DESCRIPTION

Hereinafter, an exemplary embodiment of the present disclosure will be described on the basis of the drawings.

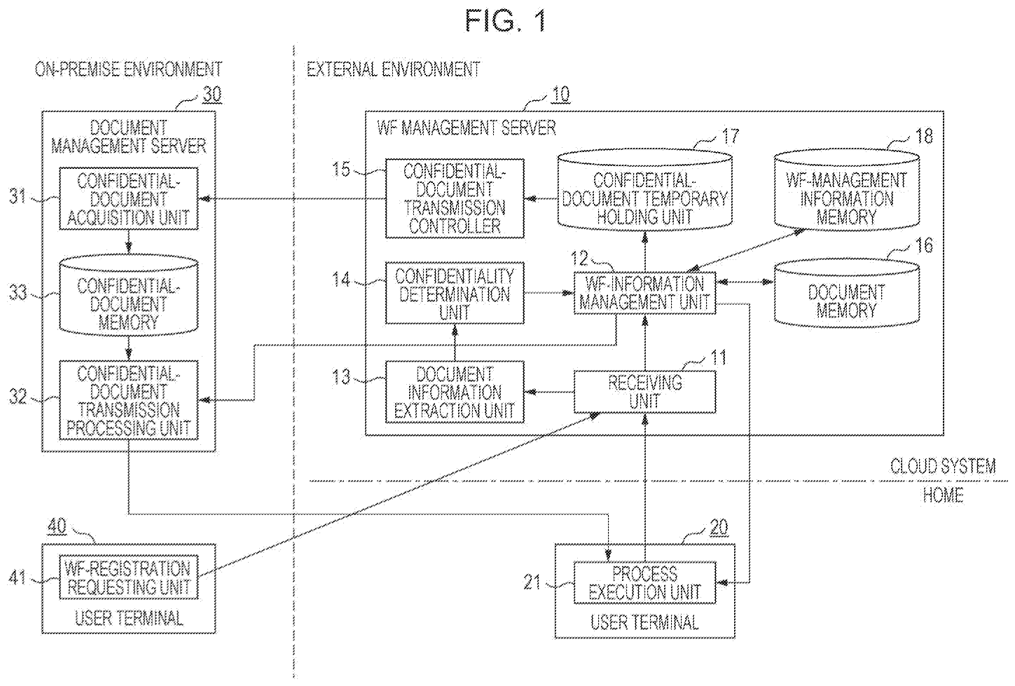

FIG. 1 is an overall configuration diagram illustrating the exemplary embodiment of a workflow management system according to the present disclosure. The workflow management system in this exemplary embodiment is installed to cover both of an on-premise environment and an external environment. The external environment is a network environment accessible by a third party. In contrast, the on-premise environment is an example of an internal environment serving as an environment other than the external environment, and is a network environment with limited access by a third party from the external environment. Typically, a network system of a company is built up in the on-premise environment.

FIG. 1 illustrates a home and a cloud system in the external environment. In this exemplary embodiment, the home is a house serving as a base of living of an employee or the like of a company that builds up the on-premise environment, and telework is performed at home. The cloud system is a system that provides services to users via a network such as the Internet. The cloud system typically permits third parties including users such as employees of the aforementioned company to access the cloud system.

FIG. 1 illustrates the external environment and the on-premise environment. In the external environment of these environments, a workflow (also simply referred to as WF) management server 10 installed in the cloud system and one of user terminals 20 disposed at home are illustrated. In contrast, a document management server 30 and a user terminal 40 that are disposed in the facility of the company are illustrated in the on-premise environment.

The workflow management server 10 is illustrated as one computer in FIG. 1 but may be implemented in such a manner that the function thereof is divided as functions of multiple computers. The workflow management server 10 may be implemented by the hardware configuration of an existing general server computer. Specifically, the workflow management server 10 includes a central processing unit (CPU) serving as a first processor, a memory such as a read-only memory (ROM), a random-access memory (RAM), or a hard disk drive (HDD), and a network interface provided as a communication unit.

The workflow management server 10 corresponds to a workflow management apparatus and includes a receiving unit 11, a workflow-information management unit 12, a document information extraction unit 13, a confidentiality determination unit 14, a confidential-document transmission controller 15, a document memory 16, a confidential-document temporary holding unit 17, and a workflow-management information memory 18. Components not used to explain this exemplary embodiment are omitted in FIG. 1.

The receiving unit 11 receives information, a file, an instruction, a request, and the like transmitted to the workflow management server 10. The workflow management server 10 manages workflow and thus receives information and the like regarding the workflow. In this exemplary embodiment, a case where document data (hereinafter, simply referred to as a document) is handled as a file will be described taken as an example. The workflow-information management unit 12 manages information required to execute the workflow managed by the workflow management server 10, workflow execution, and the like. The document information extraction unit 13 extracts, from a document received by the receiving unit 11, information regarding the document as document information. The information is required for confidentiality determination by the confidentiality determination unit 14. The confidentiality determination unit 14 determines whether the document is confidential from the document information extracted by the document information extraction unit 13. The confidential-document transmission controller 15 controls transmission of a confidential document to the document management server 30.

Documents received by the workflow management server 10 are basically documents to be processed in the workflow but may be roughly classified into a non-confidential document and a confidential document. Of these documents, the document memory 16 stores a non-confidential document. In contrast, the confidential-document temporary holding unit 17 holds a confidential document temporarily. The term “temporarily” used for holding denotes holding in a period until a confidential document is transmitted to the document management server 30.

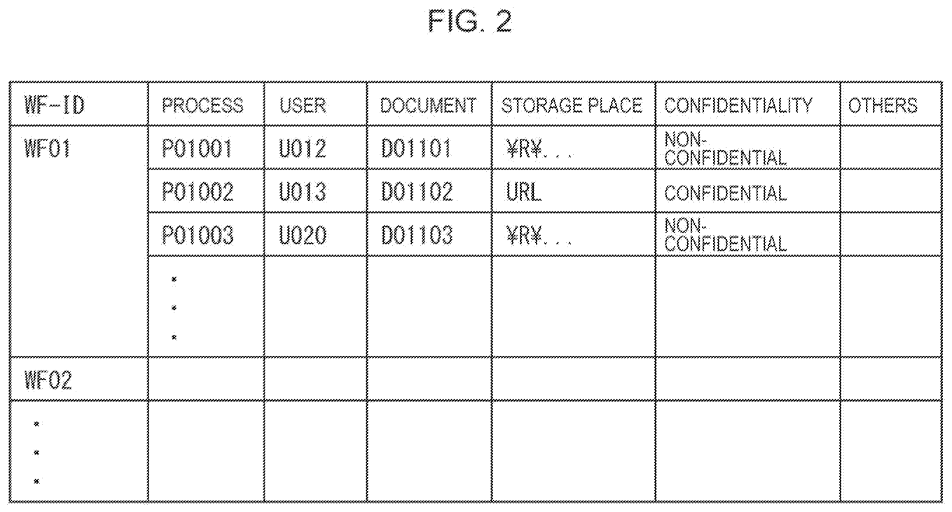

FIG. 2 is an example table illustrating a data structure of workflow management information stored in a workflow-management information memory 18 in this exemplary embodiment. The workflow management information is used for workflow management by the workflow management server 10 and is managed by the workflow-information management unit 12. In FIG. 2, WF-ID is identification information for individually identifying a received workflow. The workflow is composed of one or more processes, and each process is associated with data items such as User, Document, Storage Place, Confidentiality, and Others. In Process, identification information (for example, a processing ID) regarding the process included in the workflow is set. In User, identification information (for example, a user ID and a user name) regarding a user who intends the execution of the process is set. In Document, identification information (for example, a document ID and a document name) regarding a document to be processed in the process is set, if any. Multiple documents may be associated with one process. In Storage Place, information indicating where the document is stored is set. As described above, the document may be classified as a confidential document or a non-confidential document. In Confidentiality, flag information indicating whether the document is confidential is set. FIG. 2 illustrates an example in which Confidential and Non-confidential are respectively set as the flag information for a confidential document and a non-confidential document. In Others, one or more data items other than the foregoing data items, such as a data item for managing the progress of the workflow, are set. The data items other than the foregoing data items are not particularly referred to in this exemplary embodiment and thus are expressed as Others collectively.

The components 11 to 15 in the workflow management server 10 are implemented by cooperative operations of a computer configured as the workflow management server 10 and a program run by the CPU included in the computer. The memories 16 to 18 are each implemented by a HDD included in the workflow management server 10. Alternatively, a memory in the cloud system may be used via the network.

Each user terminal 20 is an information processing apparatus used for the telework at home and may be implemented by a general personal computer (PC) or the like including a CPU, a ROM, a RAM, a memory, a user interface, a communication unit, and other components. The user terminal 20 is used to execute processes included in the workflow at home by an employee or the like (hereinafter, referred to as a user) of the company that builds up the on-premise environment. A process execution unit 21 included in the user terminal 20 executes a process included in the workflow in response to an instruction by the user. The processes executed by the process execution unit 21 include a process in which a document is processed and which involves not only simply viewing but also user operation such as editing. The process execution unit 21 is implemented by cooperative operations of the computer configured as the user terminal 20 and a program run by the CPU included in the computer.

The processes included in the workflow are executed also in the on-premise environment in some cases and executed by using the multiple user terminals 20 in the external environment in other cases. However, the user terminals 20 in the external environment may have an equal configuration, and thus FIG. 1 illustrates only one user terminal 20. In addition, executing a process in the on-premise environment is not a feature of this exemplary embodiment, and thus a user terminal that executes the process in the on-premise environment is omitted in FIG. 1.

The document management server 30 may be implemented by the hardware configuration of an existing general server computer. Specifically, the document management server 30 includes a CPU serving as a second processor, a memory such as a ROM, a RAM, a hard disk drive, and a network interface provided as a communication unit.

The document management server 30 includes a confidential-document acquisition unit 31, a confidential-document transmission processing unit 32, and a confidential-document memory 33. Components not used to explain this exemplary embodiment are omitted in FIG. 1. The confidential-document acquisition unit 31 acquires a confidential document from the workflow management server 10. In response to a confidential-document acquisition request, the confidential-document transmission processing unit 32 transmits the confidential document to one of the user terminals 20 having transmitted the request. The confidential-document memory 33 stores the confidential document acquired by the confidential-document acquisition unit 31.

The components 11 to 12 of the document management server 30 are implemented by cooperative operations of the computer configured as the document management server 30 and a program run by the CPU included in the computer. The confidential-document memory 33 is implemented by the HDD included in the document management server 30. Alternatively, the RAM or a memory provided in the on-premise environment may be used.

The user terminal 40 is an information processing apparatus used in the company and may be implemented by a general PC or the like including a CPU, a ROM, a RAM, a memory, a user interface, a communication unit, and other components. The user terminal 40 is used by an administrator or the like for the workflow to register the workflow in the workflow management server 10. A workflow-registration requesting unit 41 included in the user terminal 40 registers the workflow in the workflow management server 10. The workflow-registration requesting unit 41 is implemented by cooperative operations of the computer configured as the user terminal 40 and a program run by the CPU included in the computer.

The programs used in this exemplary embodiment may be provided not only by a communication medium but also in such a manner as to be stored in a computer readable recording medium such as a compact disc (CD)-ROM or a universal serial bus (USB) memory. The programs provided by using the communication medium or the recording medium are installed in the computer, and various processes are implemented in such a manner that the CPU of the computer runs the programs in order.

The workflow management server 10 performs data communication with the other computers 20, 30, and 40 through the network (not illustrated) such as the Internet. The document management server 30 and the user terminal 40 perform the data communication with each other through a network (not illustrated) such as a local area network (LAN) built up in the on-premise environment.

Operations in this exemplary embodiment will then be described.

In this exemplary embodiment, the administrator of the company that builds up the on-premise environment registers the workflow in the workflow management server 10 by using the user terminal 40, and a user who is an employee or the like of the company executes a process included in the workflow registered in the workflow management server 10. In the process, a document is processed by using the user terminal 20 disposed at home.

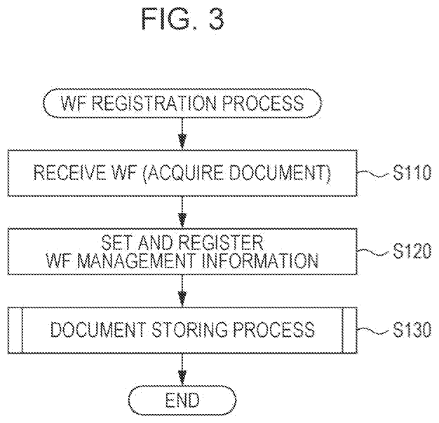

First, a process for registering workflow by the administrator will be described by using a flowchart illustrated in FIG. 3.

The workflow-registration requesting unit 41 of the user terminal 40 acquires information required to register the workflow in response to a registration operation by the administrator and then transmits the information to the workflow management server 10 to thereby request workflow registration. The request includes a document to be processed, and the document is a document stored in the user terminal 40, a document acquired by the user terminal 40 in the on-premise environment, a scanned document read by using an image forming apparatus, or the like.

The receiving unit 11 of the workflow management server 10 acquires the information transmitted from the user terminal 40 and thereby receives the workflow registration request (step S110). The workflow-information management unit 12 generates workflow management information from the acquired information and sets and registers the workflow management information in the workflow-management information memory 18 (step S120). However, the storage place and the confidentiality of the document are unknown at this stage, and thus the information items corresponding to these may be set blank.

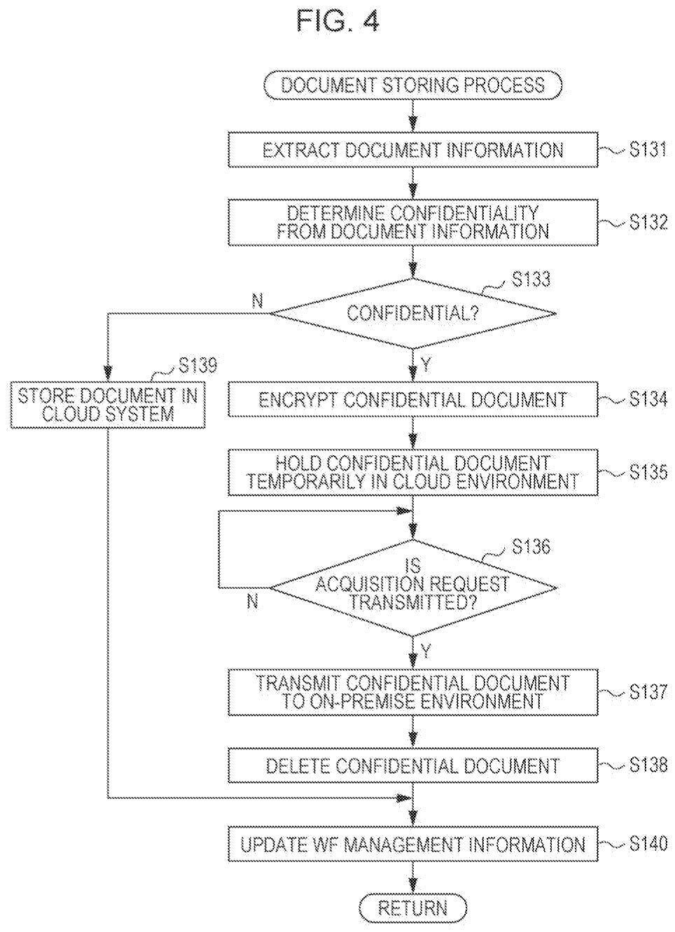

The workflow management server 10 then stores the document acquired in step S110. A process for storing the document (step S130) will be described by using a flowchart illustrated in FIG. 4. In a case where multiple documents are acquired from the user terminal 40, the same process may be repeated for each acquired document, and thus explanation is focused on one document.

First, from the document acquired by the receiving unit 11, the document information extraction unit 13 extracts document information required for confidentiality determination to be performed by the confidentiality determination unit 14 (step S131). Examples of the extracted document information include a document attribute such as a document name or a property. Alternatively, the document information extraction unit 13 executes a character recognition process on the document to search for a word or a phrase representing confidentiality, such as “company secret”, “confidential”, or “personnel secret”. If the document includes the word or the phrase, the document information extraction unit 13 extracts the word or the phrase as the document information.

Subsequently, the confidentiality determination unit 14 analyzes the document information extracted by the document information extraction unit 13 and determines whether the document is a confidential document (step S132) and notifies the workflow-information management unit 12 of the determination result.

If the determined document is a confidential document (Y in step S133), the workflow-information management unit 12 encrypts the confidential document (step S134) and causes the confidential document to be temporarily held in the confidential-document temporary holding unit 17 (step S135). Encrypting the confidential document prevents information from being leaked even if the confidential document stored in the cloud system undergoes unauthorized access.

In this exemplary embodiment, the confidential document temporarily held in the confidential-document temporary holding unit 17 is moved to the on-premise environment. However, for example, if the confidential document is temporarily held in the confidential-document temporary holding unit 17, the confidential-document transmission controller 15 notifies the confidential-document acquisition unit 31 to that effect.

In response to the notification from the confidential-document transmission controller 15, the confidential-document acquisition unit 31 of the document management server 30 transmits a confidential-document acquisition request to the confidential-document transmission controller 15.

After notifying that the confidential document is temporarily held, the confidential-document transmission controller 15 waits for the acquisition request (N in step S136). Thereafter, as described above, if the confidential-document acquisition request is transmitted from the confidential-document acquisition unit 31 (Y in step S136), the confidential-document transmission controller 15 reads out the confidential document from the confidential-document temporary holding unit 17 and transmits the confidential document to the confidential-document acquisition unit 31 in the on-premise environment (step S137) in response to the acquisition request. After verifying that the confidential document is properly transmitted, the confidential-document transmission controller 15 deletes the transmitted confidential document from the confidential-document temporary holding unit 17 (step S138). Deleting the confidential document may lead to avoidance of a state where the confidential document is left in the cloud system and thus lead to reduction of opportunities of unauthorized access to the confidential document.

In this exemplary embodiment, the confidential-document transmission controller 15 has initiative in moving the confidential document to the on-premise environment; however, the procedure does not have to be limited to this. For example, the confidential document may be processed in the following manner. Specifically, the confidential-document acquisition unit 31 transmits the acquisition request to verify whether a confidential document is temporarily held to the confidential-document transmission controller 15 regularly, for example, every one minute. If a confidential document is temporarily held in the confidential-document temporary holding unit 17 when the confidential-document transmission controller 15 receives the acquisition request, the confidential-document transmission controller 15 transmits the confidential document to the confidential-document acquisition unit 31.

As described above, if the storing target document determined as the confidential document is stored in the document management server 30 in the on-premise environment, the workflow-information management unit 12 sets Confidential as the confidentiality flag information associated with the storing target document in the workflow management information together with the storage place for the document in the document management server 30 and thus updates the content set and registered in step S120 (step S140).

In contrast, if the determined document is not a confidential document (N in step S133), the workflow-information management unit 12 stores the document in the document memory 16 in the cloud system (step S139). The workflow-information management unit 12 then sets Non-confidential as the confidentiality flag information associated with the storing target document in the workflow management information together with the storage place in the document memory 16 and thus updates the content set and registered in step S120 (step S140).

In a case where the workflow is executed in the on-premise environment, it is possible to execute the workflow in a safe environment from a security viewpoint. However, if the workflow involves user operation such as editing or approving of a document, the user operation of the document in the on-premise environment is inoperable at home in the external environment. In contrast, executing the workflow in the cloud system in the external environment does not cause the inoperability of the user operation described above. However, if the document to be processed in the workflow is a confidential document, the confidential document is held and managed in the cloud system, thus possibly causing a concern about security.

Hence, in this exemplary embodiment, the workflow is executed in the external environment as described above. If the document to be processed in the workflow is a confidential document, the document is stored in the on-premise environment in which the security is guaranteed, under the management of the workflow management server 10. In contrast, if the document to be processed in the workflow is not a confidential document, there is no concern about security, and thus the document is stored in the external environment in consideration of the convenience of the workflow to be executed in the external environment.

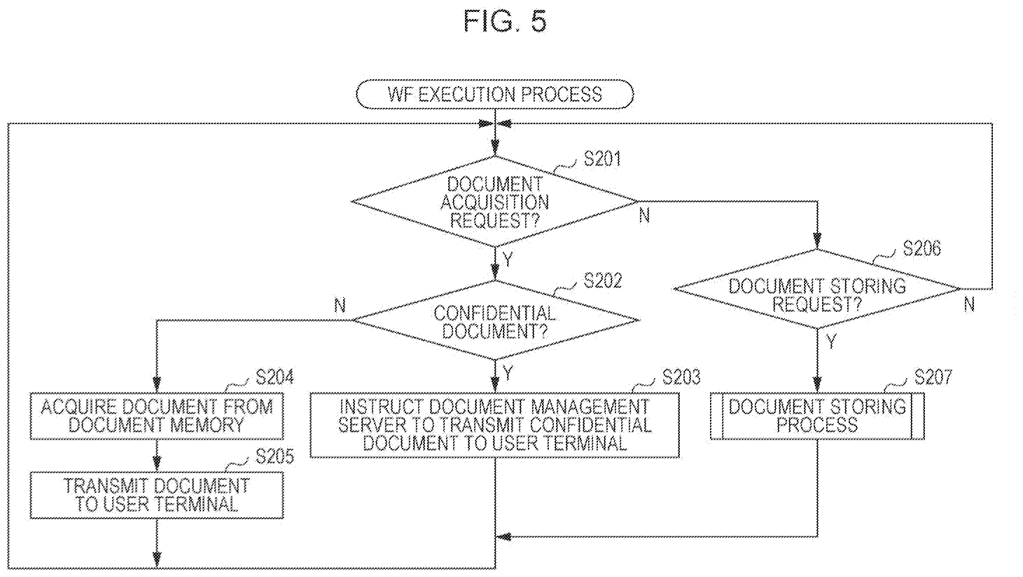

Subsequently, a process in executing the workflow registered in the workflow management server 10 as described above will be described by using a flowchart illustrated in FIG. 5.

Processes included in the workflow are executed by the users of the respective user terminals 20 in a predetermined order. The process execution unit 21 of each user terminal 20 executes a process included in the workflow in response to an instruction from the corresponding user. Since processes set in the workflow management information are each associated with the corresponding user, a user who is to execute the process is identified. If processes to be executed include a process for a document, the process execution unit 21 transmits a request to acquire the document to the workflow management server 10. The transmitted acquisition request includes information uniquely identifying the processing target document, such as a processing ID, a document ID, or a user ID.

The receiving unit 11 of the workflow management server 10 waits for the request from the user terminal 20 (N in step S201 or N in step S206). If the receiving unit 11 receives the document acquisition request (Y in step S201), the workflow-information management unit 12 checks whether the acquisition target document is a confidential document by referring to the workflow management information. If the document to be acquired by the user terminal 20 is a confidential document (Y in step S202), the workflow-information management unit 12 instructs the confidential-document transmission processing unit 32 of the document management server 30 to transmit the confidential document to the user terminal 20 (step S203). The instruction specifies the document ID of the confidential document to be transmitted and destination information, such as an IP address, regarding the user terminal 20 as the transmission destination. As the IP address or the like of the user terminal 20, information identifying a request transmission source and added to the document acquisition request may be used.

In response to the instruction, the confidential-document transmission processing unit 32 reads out the specified confidential document from the confidential-document memory 33 and transmits the confidential document to the user terminal 20 serving as the document acquisition request source specified in the destination information. The confidential document may be transmitted after being encrypted from the security viewpoint. Pieces of user information regarding respective users who perform processing in the workflow, such as the mail address or the IP address of the user terminal 20 or 40, are managed in the on-premise environment.

In contrast, if the document to be acquired by the user terminal 20 is not a confidential document (N in step S202), the workflow-information management unit 12 acquires the acquisition target document by reading out the document from the document memory 16 (step S204) and transmits the document to the user terminal 20 (step S205).

The user terminal 20 transmits the document acquisition request to the workflow management server 10 and thereby may acquire the intended document. As the result of this, even if a document in the user terminal 20 requires user operation, the user operation may be performed. Note that if the document is transmitted from the document management server 30, the document needs to be decrypted.

As described above, if an acquisition target document is a confidential document, the user terminal 20 acquires the document from the document management server 30. If the acquisition target document is not a confidential document, the user terminal 20 acquires the document from the workflow management server 10. Note that since the document is transmitted via the cloud system, it is appropriate to take some measures from the security viewpoint. In consideration of this, the workflow-information management unit 12 may acquire the acquisition target confidential document from the confidential-document transmission processing unit 32 and then transmit the document to the user terminal 20. That is, the user terminal 20 may acquire the acquisition target document from the workflow management server 10 as the acquisition request destination, regardless of whether the document is confidential.

The user edits the acquired document and updates the document on occasions. In this case, the document after the update is required to be managed again by the workflow management server 10. In this case, the process execution unit 21 transmits, to the workflow management server 10, a document storing request including the document having undergone the update according to the user operation.

If the receiving unit 11 receives the document storing request (N in step S201 and Y in step S206), the workflow-information management unit 12 executes the document storing process (step S207). The document storing process executed here may be the same as the process described by using FIG. 4, and thus explanation thereof is omitted.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A workflow management system comprising:
a first processor configured to execute workflow in an external environment;
a second processor included in an information processing apparatus disposed in an internal environment involving limited access from the external environment; and
a user terminal apparatus that is disposed in the external environment and that is used by a user for user operation of a file to be processed in the workflow,
wherein the first processor is configured to:
receive the file to be processed in the workflow;
in response to presence of confidentiality of the received file, cause the file to be held in the information processing apparatus after transmitting the file to the information processing apparatus; and
in response to presence of confidentiality of a user-operation target file acquisition of which is requested by the user, give the second processor an instruction to transmit the user-operation target file to the user terminal apparatus, and
wherein the second processor is configured to:
transmit the user-operation target file to the user terminal apparatus in response to the instruction from the first processor.

2. The workflow management system according to claim 1,
wherein the first processor is configured to:
in response to absence of the confidentiality of the received file, cause the file to be held in the external environment.

3. The workflow management system according to claim 2,
wherein the first processor is configured to:
in response to absence of the confidentiality of the user-operation target file acquisition of which is requested by the user, transmit the user-operation target file to the user terminal apparatus.

4. The workflow management system according to claim 1,
wherein the first processor is configured to:
in response to the presence of the confidentiality of the received file, encrypt and temporarily hold the file, and
delete the temporarily held file after transmitting the file to the information processing apparatus.

5. A workflow management apparatus comprising:
a first processor configured to execute workflow in an external environment,
wherein the first processor is configured to:
receive a file to be processed in the workflow;
in response to presence of confidentiality of the received file, cause the file to be held in an information processing apparatus disposed in an internal environment involving limited access from the external environment, the file being held after being transmitted to the information processing apparatus; and
in response to presence of confidentiality of a file acquisition of which is requested by a user, instruct the information processing apparatus to transmit the file to a user terminal apparatus that is disposed in the external environment and that is used by the user for user operation of the file to be processed in the workflow.

6. A non-transitory computer readable medium storing a program causing a computer that executes workflow in an external environment to execute a process comprising:
receiving a file to be processed in the workflow;
in response to presence of confidentiality of the received file, causing the file to be held in an information processing apparatus disposed in an internal environment involving limited access from the external environment, the file being held after being transmitted to the information processing apparatus; and
in response to presence of confidentiality of a file acquisition of which is requested by a user, instructing the information processing apparatus to transmit the file to a user terminal apparatus that is disposed in the external environment and that is used by the user for user operation of the file to be processed in the workflow.
